(19) United States
(12) Patent Application Publication
(10) Pub. No.: US 2008/0143477 A1
(43) Pub. Date: Jun. 19, 2008

(54) Method for Implementing Keyless Access to at Least one Vehicle Door

(75) Inventor: Matthias Eichin, Neckarwestheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/955,424

(22) Filed: Dec. 13, 2007

(30) Foreign Application Priority Data
Dec. 13, 2006 (DE) DE102006058723.5

(51) Int. Cl. B60R 25/00; G07C 9/00

(52) U.S. Cl. 340/5.61; 340/686.6

(57) ABSTRACT

A method implements keyless access to at least one vehicle door. An access system has at least one central control unit for transmitting and receiving control signals, at least one first door control unit which is assigned to a first vehicle door and has the purpose of unlocking or locking a vehicle door, at least one first proximity sensor for sensing an object located in the direct vicinity of the first proximity sensor, and a central check system which communicates with the central control unit in order to authenticate an opening signal of an identification signal transmitter. The first proximity sensor outputs a proximity signal when the object is sensed, so that the first door control unit is changed by the proximity signal from a first operating state into a second operating state.

### CROSS-REFERENCE TO RELATED APPLICATION

This application claims the priority, under 35 U.S.C. § 119, of German application DE 10 2006 058 723.5, filed Dec. 13, 2006; the prior application is herewith incorporated by reference in its entirety.

### BACKGROUND OF THE INVENTION

### Field of the Invention

The invention relates to a method for implementing keyless access to at least one vehicle door on a motor vehicle. The access system contains at least one central control unit for transmitting and receiving control signals, at least one door control unit which is assigned to a first vehicle door and has the purpose of unlocking or locking a vehicle door, at least a first proximity sensor for sensing an object located in the direct vicinity of the first proximity sensor, and at least one central control unit. The proximity sensor is interrogated by the central control unit and initiates an authentication process when there is a response.

In known keyless access systems, the entire system of the vehicle, preferably a bus system, is placed completely in the woken-up state when there is a positive identification, and a central locking device of the motor vehicle is enabled so that the vehicle doors are unlocked. The entire process from the approach of the user to the door handle until the vehicle doors are unlocked can take up to several 100 ms.

In the known systems, a proximity sensor is interrogated by a central control unit and when, for example, a hand is detected in the vicinity of the door handle an antenna system is actuated which checks whether a valid key is located in the vicinity of the door to be opened. If the check is confirmed positively, the central control unit wakes up a bus system and then cyclically transmits a message to unlock the door.

This may be a front door or a rear door. In the second case, the front door control unit will, as a master unit, wake up the rear door control unit as a slave unit, or vice versa, and then pass on or route the unlock message to the door control unit. This sequential sequence takes time, which makes rapid opening of a door impossible because the locked door cannot be unlocked as quickly as desired.

### BRIEF SUMMARY OF THE INVENTION

It is accordingly an object of the invention to provide a method for implementing keyless access to at least one vehicle door that overcomes the above-mentioned disadvantages of the prior art methods of this general type, which permits the access process to be significantly sped up.

With the foregoing and other objects in view there is provided, in accordance with the invention, a method for implementing keyless access to at least one vehicle door via an access system. The access system has at least one central control unit for transmitting and receiving control signals, at least one door control unit for unlocking and locking the vehicle door, at least one proximity sensor, and a check system communicating at least with the central control unit to authenticate an identification signal transmitter. The method includes the steps of sensing, via the proximity sensor, for an object located in a direct vicinity of the proximity sensor; outputting a control signal from the proximity sensor if the object is sensed; and actuating the door control unit and changing the door control unit from a first operating state into a second operating state in dependence on the control signal.

The access system according to the invention is characterized in that at least a first door control unit can be actuated by a proximity sensor with a control signal in such a way that the first door control unit can be changed from a first operating state into a second operating state. In this context, the proximity sensor which is located in the door is operatively connected to the second door control unit. If the proximity sensor responds, the door control unit is woken up without waking up the entire bus system.

Therefore, only the corresponding door control unit or the central control unit, which then carries out, if appropriate, the exchange of data with, for example, an identification signal transmitter, is woken up. When the central control unit transmits the unlock message, the message can be implemented immediately by virtue of the system state of the corresponding door control unit and the lock can be unlocked. If a key is not detected after a hand which is approaching has been detected, and therefore an unlock message is not transmitted, the control unit can be placed in the sleep mode again after some time. The essential difference is therefore that as a result of the actuation of the door control unit by the corresponding proximity sensor only the door control unit is woken up “locally” and not the entire system.

A further embodiment provides that the access system contains a second door control unit which is assigned to a second vehicle door. The first door control unit is configured to output door control signals with which a second door control unit can be actuated. The second door control unit is configured to receive the door control signals and to be changed from a first operating state into a second operating state by the door control signals. In this case, the door control unit of, for example, a rear door is also connected to a corresponding associated proximity sensor. If the latter responds, the proximity sensor wakes up the rear door control unit, which, as a slave unit, wakes up the master control unit, that is to say the door control unit at the front. The exchange of data with the control unit and the passing on of the unlock message are carried out more quickly in this case since the waking up of the two control units takes place in parallel with the checking of the key. If a valid key is not detected and therefore an unlock message is not transmitted, the control unit goes to sleep again after some time, for example 5 seconds.

A further preferred embodiment provides that the access system contains a bus system which is operatively connected to the central control unit and/or at least one door control unit. A monitoring link, via which the control signals can be transmitted, is set up between the proximity sensor and the door control unit, and the monitoring link is not directed via the bus system. That is to say if the proximity sensor responds, the corresponding door control unit wakes up. However, this is not in the way as previously known, specifically of the door control unit also waking up the bus system, rather it operates only locally, and the inactivity of the bus is therefore maintained. The difference is that the entire bus system is not woken up, rather only the door control unit detects the unlocking process and carries it out.

Other features which are considered as characteristic for the invention are set forth in the appended claims.

Although the invention is illustrated and described herein as embodied in a method for implementing keyless access to at least one vehicle door, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic illustration of an access system of a motor vehicle;

FIG. 2 is a flow chart illustrating an access method for a door at the front according to the prior art;

FIG. 3 is a flow chart illustrating an access method for a door at the rear according to the prior art;

FIG. 4 is a flow chart illustrating an access method for a door at the front according to the invention or new method; and

FIG. 5 is a flow chart illustrating an access method for a door at the rear according to the invention or new method.

### DETAILED DESCRIPTION OF THE INVENTION

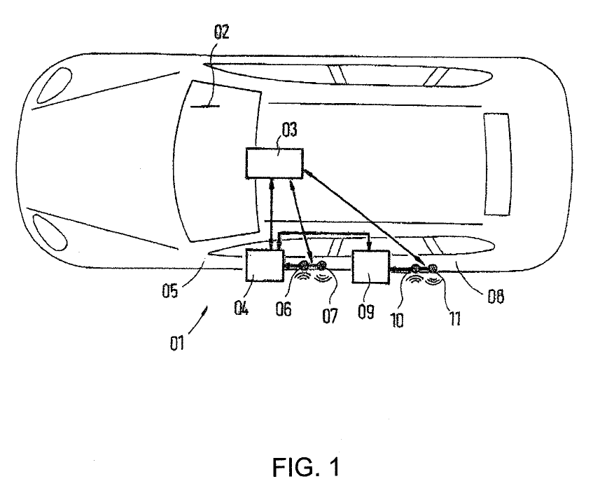

Referring now to the figures of the drawing in detail and first, particularly, to FIG. 1 thereof, there is shown a simplified configuration or illustration of a keyless access system 01 in a schematically illustrated motor vehicle 02. The access system 01 contains here a central control unit 03, a first door control unit 04, wherein the door control unit 04 is assigned to a front vehicle door 05, a proximity sensor 06 which is assigned to the first door control unit 04, a checking or antenna system 07 which is disposed next to the proximity sensor 06, and a rear door control unit 09 which is assigned to a rear vehicle door 08, having a proximity sensor 10 and a checking or antenna system 11.

The door control unit 04 is connected to the proximity sensor 06 and is actuated by it, and the door control unit 09 is connected to the proximity sensor 10 and is actuated by it. If, for example, the front proximity sensor 06 responds, the front door control unit 04 wakes up. The checking or antenna system 07 is then energized via the central control unit 03 and the checking or antenna system 07 checks whether a valid key is located in the vicinity of the door 05 to be opened. If the central control unit 03 then transmits the unlock message, the message can be implemented immediately and the lock can be unlocked by virtue of the system state of the front door control unit 04.

For access to the rear vehicle door 08, the rear door control unit 09 is connected to the associated proximity sensor 10. If the proximity sensor 10 responds, it wakes up the rear door control unit 09, which, as a slave unit, wakes up the master unit in front, that is to say the door control unit 04. The door control unit 04 is in turn connected to the central control unit 03. The waking up of the control unit 04, 09 therefore takes place in parallel with the checking of a key. If a valid key is not detected, and if an unlock message is therefore not transmitted, the control units 03, 04 and 09 therefore go to sleep again after some time.

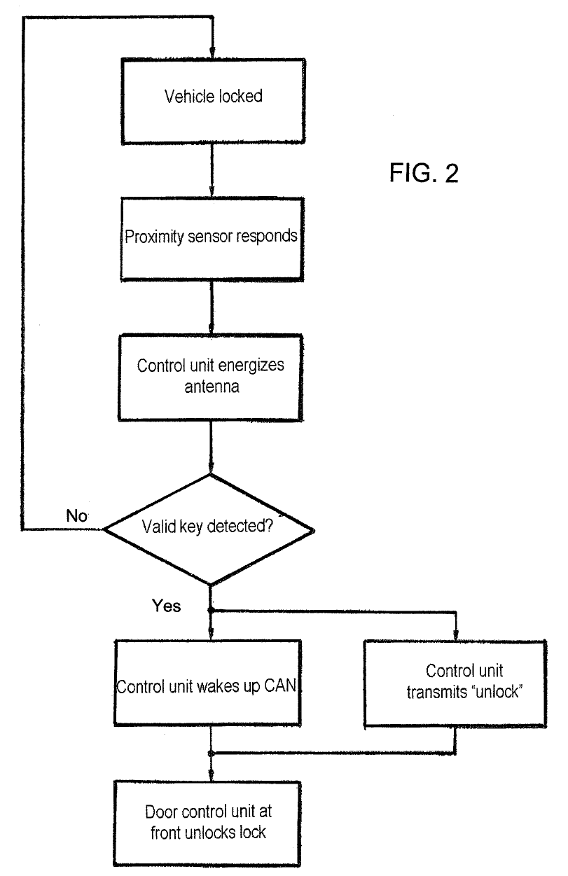

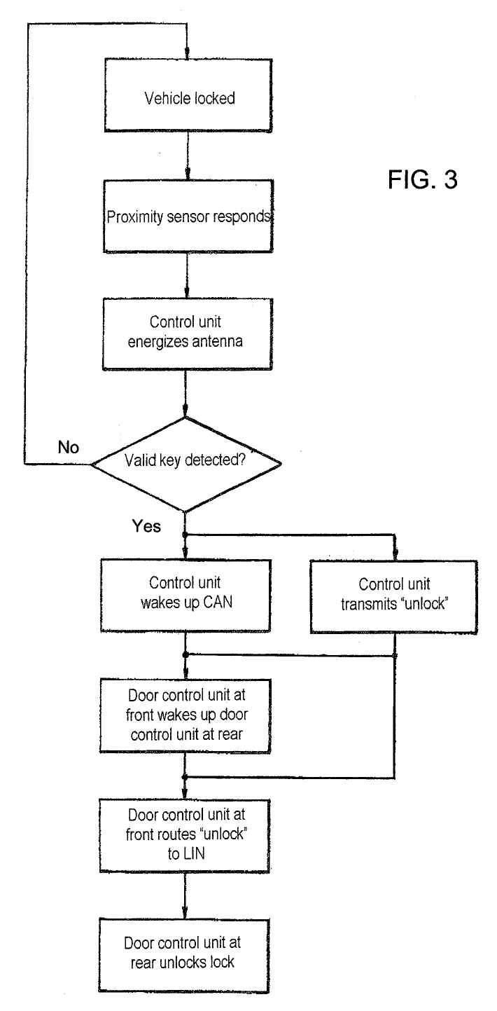

FIG. 2 shows a flow chart or an access method for a front vehicle door such as is known from the prior art. Essential features of this method are that a proximity sensor is interrogated by a central control unit (SG) and the latter actuates an antenna system when an object, for example a hand, is detected in the vicinity of the front door handle, the antenna system checking whether a valid key is located in the vicinity of the door to be opened. If this is confirmed positively, the central control unit wakes up a CAN (Controller Area Network) networked bus system and it then cyclically transmits a message to unlock the door. As is illustrated in FIG. 2, this can be a front door (CAN networked), or as illustrated in the diagram in FIG. 3, a LIN (local interconnect network) networked door. As is shown in the second diagram in FIG. 3, the front door control unit (TSG at the front), as a LIN master unit, must wake up the rear door control unit (TSG at the rear) as an LIN slave unit, and then pass on (route) the unlock message to the door control unit. This sequential sequence requires a large amount of time, which makes rapid opening of the door impossible.

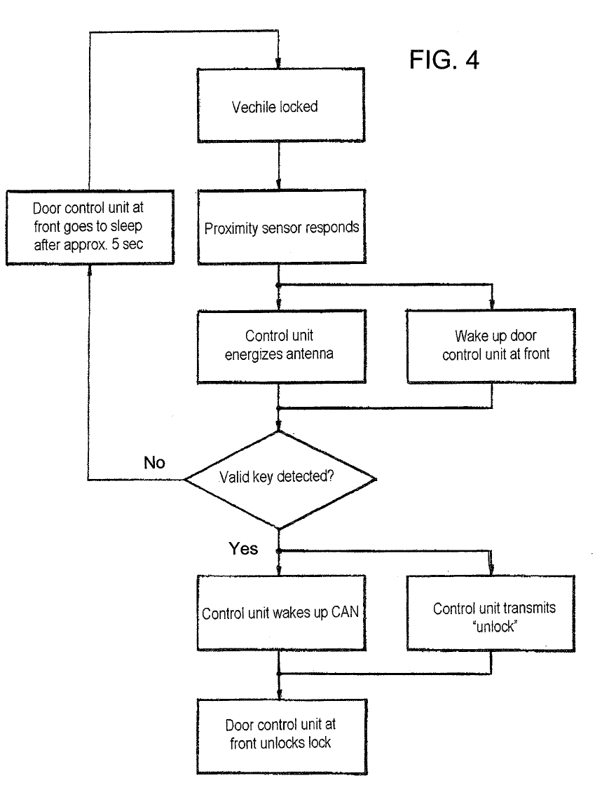

The new access method according to the diagram on FIG. 4 discloses a significant speeding up of this access. Here, the proximity sensor which is disposed in the door is connected to the respective door control unit. If the sensor responds, the door control unit at the front is woken up, but not in the way as described in the diagrams in FIGS. 2 and 3, according to which the door control unit also wakes up the bus system, but here it only occurs locally so that the bus system continues to be in a sleep mode. If the central control unit then transmits the unlock message, the message can be implemented immediately and the lock can be unlocked by virtue of the system state of the front door control unit.

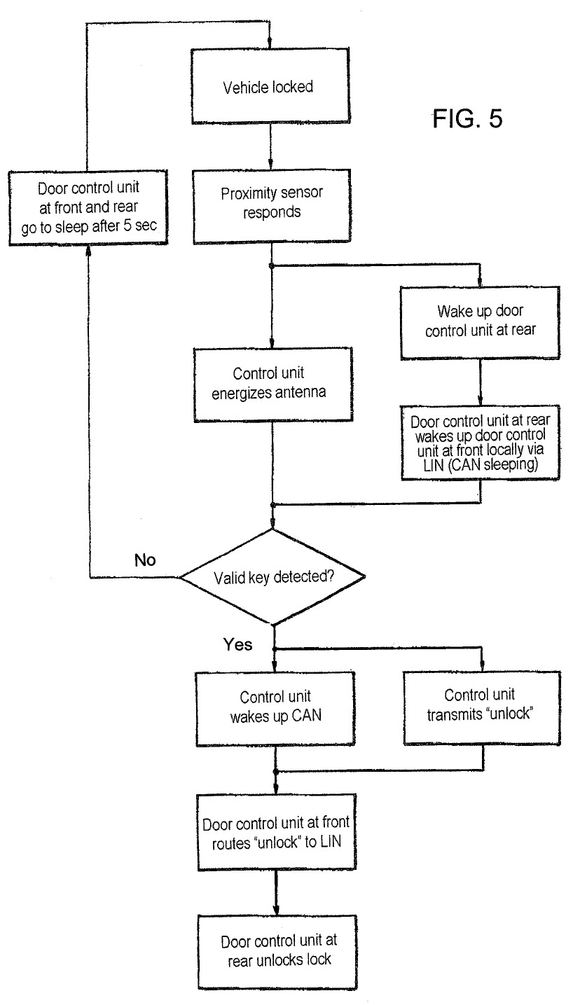

For access to a rear door, illustrated and shown in diagram FIG. 5, the rear door control unit is also connected to the associated proximity sensor. If the latter responds, it wakes up the rear door control unit, which, as a LIN slave unit, wakes up the LIN master unit, that is to say the door control unit at the front, in which case, again as already described in the diagram FIG. 4, the inactivity of the bus is maintained.

The reception from the central control unit, as well as the passing on of the unlock message, are carried out more quickly in this case since the waking up of the two control units takes place in parallel with the checking of a key (see FIG. 5).

If a valid key is not detected, and therefore an unlock message is not transmitted, the control units go to sleep again after some time (for example 5 seconds).

The schematic access methods and systems which are illustrated here have been described above using just one exemplary embodiment. Of course, numerous modifications and refinements are possible without departing from the inventive idea on which the innovation is based.

1. A method for implementing keyless access to at least one vehicle door via an access system having at least one central control unit for transmitting and receiving control signals, at least one door control unit for unlocking and locking the vehicle door, at least one proximity sensor, and a check system communicating at least with the central control unit to authenticate an identification signal transmitter, the method comprises the steps of:
sensing, via the proximity sensor, for an object located in a direct vicinity of the proximity sensor;
outputting a control signal from the proximity sensor if the object is sensed; and
actuating the door control unit and changing the door control unit from a first operating state into a second operating state in dependence on the control signal.

2. The method according to claim 1, which further comprises:
providing the access system with at least one further door control unit, the further door control unit and the door control unit defining a first and a second door control unit;
after the first door control unit has been actuated, actuating the second door control unit via control signals from the first door control unit; and
after actuation of the second door control unit has taken place, changing the second door control unit from the first operating state into the second operating state.

3. The method according to claim 1, which further comprises:
providing a bus system being operatively connected to at least one of the central control unit and the at least one door control unit; and
transmitting the control signal to the at least one door control unit without being directed via the bus system, such that the bus system remains in a state of rest during an activation of the at least one door control unit.

4. A method for implementing keyless access to at least one vehicle door via an access system having at least one central control unit for transmitting and receiving control signals, at least one door control unit for unlocking and locking the vehicle door, at least one proximity sensor for sensing an object located in a direct vicinity of the proximity sensor, the proximity sensor outputting a control signal when the object is sensed, and a check system communicating at least with the central control unit to authenticate an identification signal transmitter, which further comprises the steps of:
actuating the door control unit via the control signal from the proximity sensor such that the door control unit is changed from a first operating state into a second operating state.
